(19) United States
(12) Patent Application Publication
(10) Pub. No.: US 2007/0174416 A1
(43) Pub. Date: Jul. 26, 2007

(54) Spatially articulable interface and associated method of controlling an application framework

(75) Inventors: Keith Waters, West Newton, MA (US); Bradford Lassey, Cambridge, MA (US); Phillip Zakielarz, Rochester, NY (US); Clayton Williams, Heber City, UT (US)

Correspondence Address: OBLON, SPIVAK, MCCLELLAND, MAIER & NEUSTADT, P.C., 1940 DUKE STREET, ALEXANDRIA, VA, 22314, US

(73) Assignee: FRANCE TELECOM, Paris (FR)

(21) Appl. No.: 11/335,600

(22) Filed: Jan. 20, 2006

(51) Int. Cl. G06F 15/16

(52) U.S. Cl. 709/217; 700/94

(57) ABSTRACT

A mobile device is provided for imparting spatially articulable control to an application program. The device includes a display for presenting the GUI. A spatial detection unit is configured to detect spatial movement of the mobile device and provides an output responsive to the detected spatial movement. A data processor is configured to provide a platform for executable code, and, monitors and provides the output to a communication channel. Executable code executes on the platform of the data processor. The executable code includes, an interpreter library which is operably linked to the communication channel and is configured to implement communication with the data processor to receive the output. The interpreter generates events relative to the interpreter library. A plug-in has an interface cooperatively linked to the interpreter library to receive corresponding generated events. The generated events are provided to a script interface of the plug in. A browsing program is cooperatively linked to the plug-in and configured to receive the generated events therefrom. In this way, the script interface supports a scripting environment such that the browsing program is controlled on the display in response to the spatial movement of the mobile device.

### BACKGROUND OF THE INVENTION

The present invention relates to a spatially articulable control interface, and, more particularly, to an application framework in which spatial movement of a device imparts control events to a scriptable environment of an application program.

The “background” description provided herein is for the purpose of generally describing the context of the invention. Work of the presently named inventors described in this description, as well as aspects of the description which may not otherwise qualify as prior art at the time of filing, are neither expressly or impliedly admitted as prior art against the present invention.

Mobile devices, such as a cellular phone, MP3 player, PDA, etc., are becoming increasingly more complicated to operate due to the additions of functions and the miniaturization of traditional keyboards and controls. For example, mobile device functionality has greatly increased across devices as multiple functions are consolidated to a single device. These multi-functions include text messaging, e-mail, multimedia playback, web browsing, and the like. At the same time, and in conflict with the desire for more functionality, there is an increasing pressure to further reduce the physical size and weight of such mobile devices.

As to the desired reduction in size, displays are becoming clearer and therefore more readily reducible in size, and the internal components, such as electronics and data storage, are becoming smaller quite rapidly. This has placed enormous pressures on designers to reduce the size of user controls or interfacing for the various functions.

As the user interfaces to mobile devices are becoming smaller and are required to support an increasing set of functionalities, it is difficult for inexperienced users, commuters, and the elderly, to access the full functionality of the device due to the difficulties in navigating the small physical controls.

Accordingly, there is a need for a more simplified user interface, which is not limited by the aforementioned reduction in size or increase in functionality of mobile devices.

### SUMMARY OF THE INVENTION

The present invention provides a method of imparting control to an application program of a mobile device. The method includes displaying a graphical user interface (GUI) of the application program to a display of the mobile device. The occurrence of a defined spatial movement is determined by a spatial platform of the mobile device. A corresponding control signal is generated by the mobile device in response to the occurrence. The control signal is provided to a plug-in program of the application framework. The control signal of the plug-in is presented to the application program. A script operating in a scripting environment supported by the application program is executed for imparting control thereto in accordance with the spatial movement of the mobile device.

In a further aspect of the invention a mobile device includes a display configured to present a graphical user interface (GUI). A spatial detection unit is configured to detect spatial movement of the mobile device and provide an output responsive thereto. A data processor is configured to provide a software platform, and, configured to monitor and provide the output to a communication channel. Executable code operative to execute on the platform, includes, an interpreter library which is operably linked to the communication channel. The interpreter library is configured to implement communication with the data processor to receive the output. The interpreter generates events relative to the interpreter library. A plug-in has an interface cooperatively linked to the interpreter library to receive corresponding generated events. The generated events are provided to a script interface of the plug-in. A browsing program presents the GUI to the display is cooperatively linked to the plug-in which is configured to receive the generated events therefrom. The script interface supports a scripting environment such that the browsing program is controlled in response to the spatial movement of the mobile device.

In still another aspect of the invention, a system of imparting control to an application program is provided. A hand held device of the system includes a spatial detection unit which is configured to detect spatial movement of the hand held device and provide an output responsive thereto. A data processor is configured to monitor and provide the output to a communication channel. A host device of the system includes a display configured to present a graphical user interface (GUI). Executable code is operative to execute on a platform of the host device and includes, an interpreter library operably linked to the communication channel. The interpreter library is configured to implement communication with the data processor to receive the output. The interpreter generates events relative to the interpreter library. A plug-in has an interface cooperatively linked to the interpreter library to receive corresponding generated events. The generated events are provided to a script interface of the plug-in. A browsing program presents the GUI and is cooperatively linked to the plug-in which is configured to receive the generated events therefrom. The script interface supports a script environment such that the browsing program is controlled in response to the spatial movement of the hand held device.

It is to be understood that both the foregoing general description of the invention and the following detailed description are exemplary, but are not restrictive, of the invention.

### BRIEF DESCRIPTION OF THE SEVERAL VIEWS OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of the exemplary mobile device of the present invention;

FIG. 2 shows a high level block diagram of an architecture of the exemplary mobile device of FIG. 1;

FIG. 3 is flow chart describing an exemplary process flow of the mobile device of FIG. 1; and,

FIG. 4 is a flow diagram of user input action to the mobile device of FIG. 1.

### DETAILED DESCRIPTION OF THE INVENTION

Certain terminology used in the following description is for convenience only and is not limiting. The term “articulable” and “spatial movement” as used herein refers to a full range of motion in three dimensional space with respect to a device. This range of motion includes, full rotation along any axis, partial rotation, and/or non-rotational movement such as a “flick” or “shake.” A “flick” as used herein is defined as a quick movement (predetermined in duration) in one direction, then back again to an original starting point. A “shake” as used herein includes sequential flicks. Likewise articulable and/or spatial movement as used herein includes angled and/or linear movement in any direction which does not require a return to the original staring point. In the drawings, the same reference numerals are used for designating the same elements throughout the several figures.

The present invention is directed to an input mechanism for scripting interfaces based upon the detection of spatial movement of a device. Motions such as hand shaking, tilting, twisting, rotating, as well as wrist flicking in any direction, are translated into events which are processed by a scripting environment.

The present invention provides a mobile device including an application program which supports a script environment, in the exemplary embodiment, a World Wide Web Browser is utilized. The web browser provides a Graphical User Interface (GUI), which presents a computer environment that displays, or facilitates the display of on-screen options in the form of icons, menus, radio buttons, and the like, such as typically presented in a Windows-based operating system. Such browsers may include the Mozilla Minimo®, Opera® and Thunderhawk® browsers supported by the Symbian®, Linux®, and/or Windows CE operating systems of mobile devices. Of course, those skilled in the art will recognize that the exemplary embodiment may embrace non-mobile platforms such as Unix, Windows Vista and corresponding and browsing technologies such as Netscape Navigator, Microsoft Internet Explorer, and Firefox.

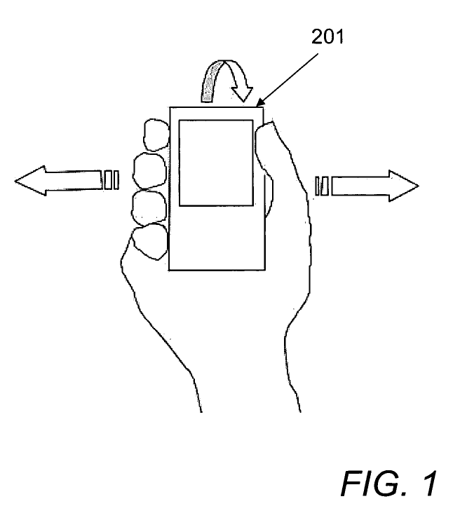

FIG. 1 shows an exemplary input mobile device 201. Spatial motions or hand movements such as hand shaking, for example the illustrated tilting (also known as pitch) and wrist flicking left and right are automatically translated into events (here, pitch up, yaw left, and yaw right, which are illustrated by the arrows). Of course, the arrows are illustrative rather than exhaustive of potential movement as noted above.

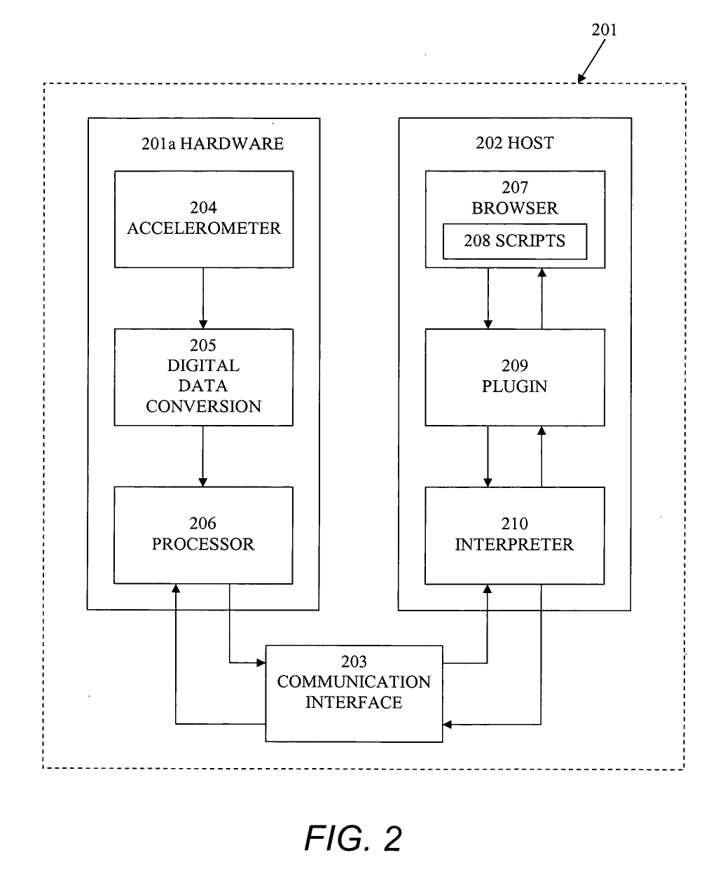

Referring now to FIG. 2, the exemplary embodiment provides the mobile device 201 to obtain defined events from corresponding defined hand movements of the mobile device 201. These events are passed to host 202, which employs a web browser to provide user interaction based upon or in response to such events.

More specifically, a high level block diagram of an architecture of the exemplary mobile device is shown in FIG. 2. The mobile device 201 includes a hardware platform 201a having an accelerometer 204, digital data conversion 205 and processor 206. The Host, or software, 202 includes browser 207, scripts 208, plug-in 209, and interpreter 210. The mobile device 201 communicates with host 202 via a communication interface 203.

The mobile device 201 is hardware and/or software, or combinations thereof, including: a motion detector (e.g., a multidirectional accelerometer 204). An exemplary accelerometer would output analog data for recognizing movement of the device 201 within three-dimensional space. This analog data is then converted to digital data by the digital data conversion unit 205 functioning as and A/D (analog to digital) converter. If the accelerometer 204 outputs digital positional data compatible with the processor 206, the digital data conversion unit 205 may be eliminated.

Actions are defined user driven motions or movements of the mobile device 201 (for example, an abrupt motion to the left or right are two such actions, as indicated by the horizontal arrows in FIG. 1). Actions are not limited to left or right, but the detection algorithm to be described only employs these two specific actions for purposes of illustration.

The defined motions of the device 201 that is detected may be pitch or tilt that is a signed measurement of the angle the device makes with a reference plane. For purposes of the exemplary embodiment, the reference plane is horizontal (i.e., parallel to the ground although it may be any steady state position). The reference plane may be steady state position (with minor movement being below threshold detection levels and therefore ignored as not being legitimate input). Using Cartesian co-ordinates with the X and Y axes being in the reference plane and the Z axis being perpendicular to the reference plane, Up and down movements would be detected along the Z axis, right to left movements are detected along the X axis, forward and backward movements are detected along the Y axis. Tilt or pitch is detected along the Z and Y axes, yaw is detected along the X and Y axes, and roll is detected along the Z and X axes. Thresholds of movement eliminate minor movements of the mobile device that are not intended to be inputs and thresholds of acceleration eliminate movements greater than the distance thresholds that occur over such a long period of time that they are judged not to be meaningful inputs.

Each of the above six movements can further be distinguished as to direction, for example tilt may the positive to be up or negative to be down, thereby involving twelve different inputs. Simultaneous movement along all three axes may be a thirteenth unique input, as a modification, the co-ordinates may be polar, instead of Cartesian.

The spatial movement interface of the exemplary embodiment interprets information from one or many accelerometers, generally the accelerometer 204. The accelerometer 204 provides analog or Pulse Width Modulation (PWM) signals, which are captured into a digital representation by the digital data conversion unit 205. The raw acceleration data is then processed by microprocessor 206. The microprocessor 206 functions as an instruction set that interprets the acceleration data to judge if a defined event has occurred. Depending on the mode the device 201 is in, information about the position or past position of the device 201 is sent to the host 202. The host 202 is typically an instruction set including a web browser 207.

There are a variety of small device motion sensors, data conversions and processors that exist today that can be used in the embodiment, for example as disclosed in: U.S. Pat. No. 4,988,981, issued Jan. 29, 1991 to Zimmerman et al, whose entire disclosure is incorporated herein; and in International Publication Number WO 01/27735 Al, published Apr. 19, 2001, whose entire disclosure is incorporated herein.

The processor 206, for example may be embodied as software, middleware or firmware. Likewise, processor 206 may be embodied as programmable logic, an Application Specific Integrated Circuit (ASIC), microcontroller, or microprocessor or general purpose computer. The processor 206 translates the positional data from the positional detector or movement detector 204 (for example the accelerometer) into defined events that can be understood by the host 202.

The defined events output from the processor 206 are communicated from the device 201 through the communication interface 203 to the host 202 as defined event representing signals.

The communication interface 203 operatively connects the mobile device 201 and the host 202 for bi-directional communication for the exchange of signals, for example event representation signals from the device 201 to the host 202, controls from the host 202 to the device 201, and other data. The communication interface 203 may employ any type of transmission line, in the exemplary embodiment, the communication interface 203 is a hard wired data pathway for stand alone configuration. Of course those skilled in the art will recognize that in alternative embodiments, communication interface 203 may be embodied by wireless technologies (for example cellular, Bluetooth, Wi-fi, Wimax, short range radio frequency, hard wiring, optical, IR, and satellite) and less desirably cabling. In such embodiments, the mobile device would be a hand held control, separate from the software of host 202.

Events communicated by communication interface 203 are then handled by a browser, for example using the scripting environment (for example, the scripts 208 of the browser 207 of the host 202).

The interpreter 210 has a library to implement the communications and control specification of the device for the host 202. It is independent of the communication medium, but may use the software of the host 202 to perform communications through the communication interface 203. The interpreter 210 is event based, passing events to zero or more appropriate registered event listeners as soon as a complete data message is received from the device 201. The mode of the device 201 is manipulated by sending control messages to the device 201 from the interpreter 210 through the communication interface 201 and waiting for the device 201 to acknowledge those control messages. These functions are preferably implemented with software.

The browser 207 is aware of the interpreter 210 through the browser's plug-in interface 209. The plug-in code registers itself to an instance of the interpreter as an event listener and events are passed to it when they are received from the device 201. The plug-in 209 may or may not respond to the event representing signals passing through the communication interface 203. In particular, the plug-in 209 may expose those event signals to scripts 208, or use the event signals to control the browser directly. The plug-in 209 has access to the control functions of the interpreter 210, which may also be exposed to scripts. These functions are preferably implemented with software.

The scripts 208 of the host 202, in FIG. 2, allow web developers to dynamically change the content of their websites based on the input from the device 201. For example, tilt data from the device controls a web-based map, or gestures recognized by the device 201 signals for an abrupt change in content each time they occur. The script interface 208 is defined by the implementation of the plug-in 209, which may or may not expose any amount of information from the device. These functions are preferably implemented with software. Those skilled in the art will recognize scripts as a content provider defined executable, whether it be server side or client side executed, such as embodied by executables of Java, Javascript, PHP, ASP, CGI and Perl.

Any process descriptions or blocks in flow charts should be understood as representing modules, segments, portions of code which include one or more executable instructions for implementing specific logical functions or steps in the process, and alternate implementations are included within the scope of the exemplary embodiment of the present invention in which functions may be executed out of order from that shown or discussed, including substantially concurrently or in reverse order, depending upon the functionality involved, as would be understood by those skilled in the art.

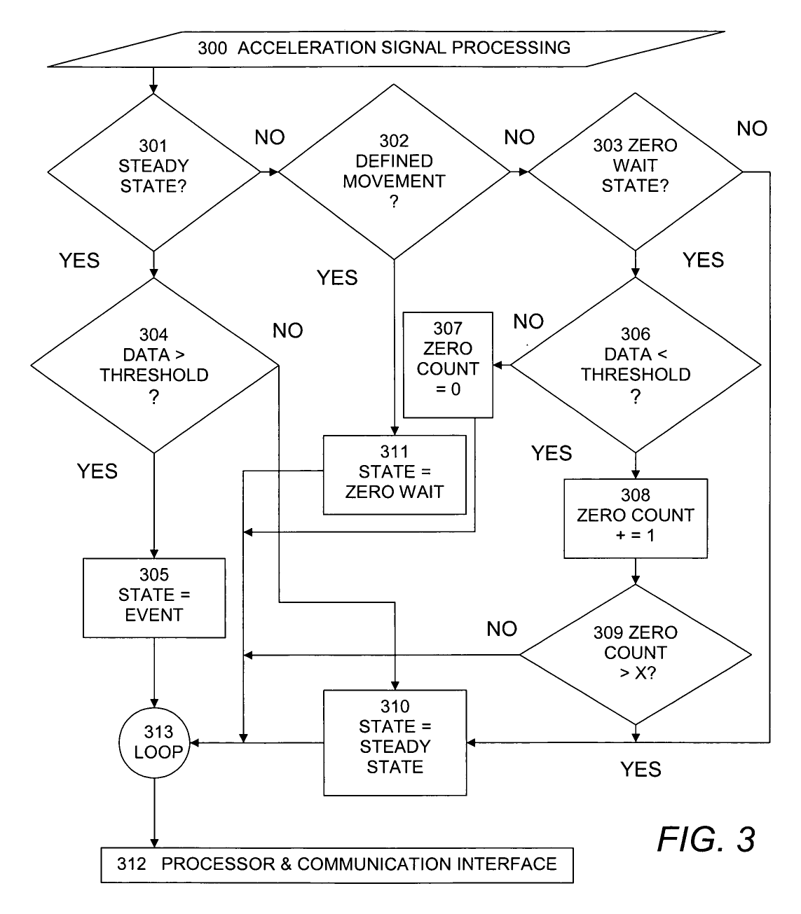

The software, as disclosed with respect to the flowchart of FIG. 3 runs on the processor 206 and communicates with the host 202 through the communication interface 203, which is in addition to the algorithms used to interpret the acceleration data from the accelerometer 204. The communication between the host 202 and the device 201 is handled on the device side by a state machine. The host 202 sends commands to the device 201 whereby the state of the device 201 is updated. This updated state determines what information, if any, is sent to the host 201. The device 201 sends information when the change in position of the device 201 is interpreted as a defined action to be a defined event, as well as sends a data stream that may or may not have been processed.

An action is an abrupt motion, e.g. to the left or right. An action is distinguished from other motions (noise, for example when the user is jostled as a passenger in a moving vehicle) that may occur while the device is being used.

The detection system operates in a loop that is entered when the device is put into action driven mode. FIG. 3 shows the flow of data 400 from the accelerometer 204 in FIG. 2 to the host 202 by communication step 407 as implemented with the communication interface 203. This loop is enclosed in the processor 206 in FIG. 2, where the binary data from the digital data conversion 205 (which, for example may be an analog to digital converter, ADC) is the input to the processor 206 (which, for example, may be a general purpose computer processor and software). The interpreter 210 may be a table look-up to convert event control signals to browser specific controls. The Plugin 209 may be a program module directly interfacing with the browser 207 and giving a standard browser 207 additional functionality relating to the hand held mobile device.

Each time a new piece of data is available as determined by step 402, the new event data is stored into a small memory array of device 201 (not shown) that contains the previous N data points, step 403.

At this point the data usually contains noise, which is preferably filtered out, for example, with a low pass filter (not shown) that takes the average of all the data in the array for each new data point. Such filtering may be accomplished with the processor 206.

The resulting signal is passed into another filter (not shown) that removes any DC component of the signal. The DC component may be a result of a data stream from the digital data converter being unsigned. The filter removes this DC component by taking the first difference (discrete time differentiation, step 404). Such filtering may be accomplished with the processor 206.

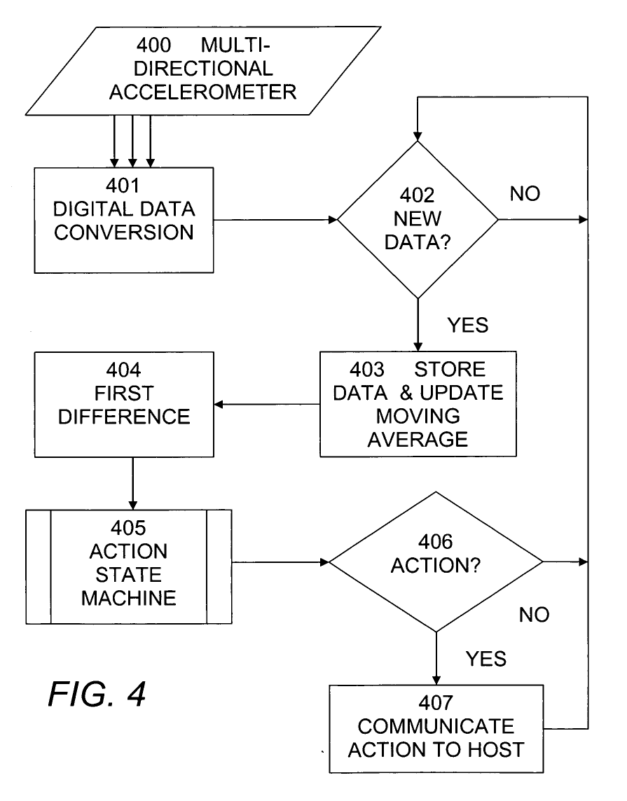

Next, the filtered data stream resulting from the acceleration signal processing 300 of FIG. 3, more specifically the steps 400, 401, 402, 403 and 404 of FIG. 4 as preferably implemented with the processor 206, is passed into a state machine 405 that determines in step 406 if a defined action has occurred. When a defined action has occurred to be judged as a defined event, an event signal is sent through the communication interface 203 to the host 202 according to step 407.

The state machine flowchart of FIG. 3 moves through its states based on a simple decision structure that considers the previous state of the machine and the incoming data from step 300.

If the machine is in its steady state as determined by step 301 and an action or event signal threshold is crossed as determined by step 304, the state machine goes into an action state 305 corresponding to which specific threshold was crossed. For clarity, only one set of steps 304, 305 are illustrated for one defined event, but preferably a different set is provided for each defined event. The main processing loop 313 of the device 201 examines the state of the machine, and if the machine is in an action state, appropriate information will be sent to the host over the communication channel or interface 203, step 312.

The signal that results from an abrupt action is much more complicated than a quick acceleration in one direction. It is not uncommon for the signal to cross many thresholds after the initial signal is acknowledged. Because of this, when the signal is not for a defined movement, step 302, judged not to be in the steady state in step 301, the state machine waits until the signal returns to a steady state, steps 303 - 311, before more actions are acknowledged. To accomplish this, the machine is put into the zero wait state. Once the machine is in this state it waits for X consecutive zeros (a zero occurs when the absolute value of the signal is below a threshold, step 306, and then step 308 increments the X count; if the absolute value of the signal is not below the threshold, step 307 resets the zero count and the loop 313 returns processing to step 300). After X consecutive zeros, step 309, the machine is returned to the steady state in step 310 and actions can once again be acknowledged by the loop 313 returning processing to step 300.

Communications for the communication interface 203 may take place over any type of medium as previously described above. Communications between the host 202 and device 201 may be polled or event driven, e.g., which is determined by the host. Specifically, the host may request information about the position of the device (polled), or the device may send information to the host independently (event driven).

As a variation of the embodiment, the device 201 can be placed in a specific mode by a command from the host 202 so that the device 201 will only send information corresponding to abrupt left or right motions (yaw). As another example, the device may send a stream of tilt data (pitch) that corresponds to the angle the device is being held relative to the ground. Also roll data may be sent.

Obviously, readily discernible modifications and variations of the present invention are possible in light of the above teachings. It is therefore to be understood that within the scope of the appended claims, the invention may be practiced otherwise than as specifically described herein. For example, while described in one or both of software and hardware components interactively cooperating, it is contemplated that the system described herein may be practiced entirely in software. The software may be embodied in a carrier such as magnetic or optical disk, or a radio frequency or audio frequency carrier wave.

Thus, the foregoing discussion discloses and describes merely exemplary embodiment of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

1. A method of imparting control to an application program of a mobile device, comprising:
displaying a graphical user interface (GUI) of the application program to a display of the mobile device;
determining the occurrence of a defined spatial movement of the mobile device;
generating a corresponding control signal in response to the occurrence;
providing the control signal to a plug-in program of the application program; and
presenting the control signal of the plug-in to the application program; and
executing a script operating in a scripting environment supported by the application program, to impart control thereto in accordance with the spatial movement of the mobile device.

2. The method of claim 1, wherein, the control signal is provided by a plug-in executable interfacing the application program.

3. The method of claim 1, wherein said determining is implemented with a state machine of the mobile device.

4. The method of claim 1, further comprising:
thereafter, monitoring further movement of the mobile device and judging when the hand held mobile device movement is in a substantially steady state; and
thereafter, in response to the judging of a steady state, repeating the steps of determining, generating and providing with respect to a different defined movement.

5. The method of claim 1, wherein the determining includes filtering noise and DC components from an accelerometer output within the device.

6. The method of claim 1, wherein the generating produces control signals via a plug-in application, the control signals being processed through a scripting environment of a web browsing application program.

7. A mobile device, comprising:
a display configured to present a graphical user interface (GUI);
a spatial detection unit configured to detect spatial movement of the mobile device and providing an output responsive thereto;
a data processor configured to provide a software platform and configured to monitor and provide the output to a communication channel;
executable code operative to execute on the platform, including,
an interpreter library operably linked to the communication channel and configured to implement communication with the data processor to receive the output, the interpreter generating events relative to the interpreter library,
a plug-in having an interface cooperatively linked to the interpreter library to receive corresponding generated events, the generated events being provided to a script interface,
a browsing program configured to present the GUI and cooperatively link the plug-in to receive the generated events therefrom,
wherein the script interface supports a script environment such that the browsing program is controlled in response to the spatial movement of the mobile device.

8. The mobile device of claim 7, further comprising:
a memory configured to store data points of the output.

9. The mobile device of claim 7, wherein the spatial detection unit further comprises:
a state machine configured to determine spatial movement by comparison to a previous movement determination.

10. A system of imparting control to an application program, comprising:
a hand held device having,
a spatial detection unit configured to detect spatial movement of the hand held device and providing an output responsive thereto
a data processor configured to monitor and provide the output to a communication channel;
A host device, having,
a display configured to present a graphical user interface (GUI) executable code operative to execute on a platform of the host device, including,
an interpreter library operably linked to the communication channel and configured to implement communication with the data processor to receive the output, the interpreter generating events relative to the interpreter library,
a plug-in having an interface cooperatively linked to the interpreter library to receive corresponding generated events, the generated events being provided to a script interface,
a browsing program for presenting the GUI and cooperatively linking the plug-in to receive the generated events therefrom,
wherein the script interface supports a scripting environment such that the browsing program is controlled in response to the spatial movement of the hand held device.

11. A computer readable carrier including computer program instructions that cause a computer to implement a method of controlling an application program in response to spatial movement of the computer, the method comprising:
displaying a graphical user interface (GUI) of the application program to a display of the mobile device;
determining the occurrence of a defined spatial movement of the mobile device;
generating a corresponding control signal in response to the occurrence;
providing the control signal to a plug-in program of the application program; and
presenting the control signal of the plug-in to the application program; and
executing a script of a scripting environment supported by the application program to impart control thereto in accordance with the spatial movement of the mobile device.
